(19) United States
(12) Patent Application Publication
(10) Pub. No.: US 2004/0187702 A1
(43) Pub. Date: Sep. 30, 2004

(54) Forced Venting Fry Utensil

(76) Inventor: Zhaoxia Xu, Ypsilanti, MI (US)

Correspondence Address: ZHAOXIA XU, 4694 SYCAMORE DR., YPSILANTI, MI, 48197, US

(21) Appl. No.: 10/249,240

(22) Filed: Mar. 25, 2003

(51) Int. Cl. A47J 37/10

(52) U.S. Cl. 99/422

(57) ABSTRACT

A forced venting fry utensil. The fry utensil includes a lid (20), a pan (22), a blowing device (24), and a venting device (26). Blowing device (24) comprises an in-take conduit (28) mounted on lid (20), a filter (30) engaged with in-take conduit (28), a fan (34) powered by a motor (32) blowing fresh air into the fry utensil through in-take conduit (28). Venting device (26) comprises a venting conduit (40) mounted on lid (20) and a filter (42) engaged with venting conduit (40) for reducing the oil vapor content from the grease-laden air generated during the frying process.

### BACKGROUND OF THE INVENTION

This invention generally relates to cooking utensils. More specifically, this invention relates to fry utensils with forced venting.

Fried foods, such as fried shrimp, fried fish, fried chicken, etc., are tasteful. Two of the most important characteristics of fried foods are: outside, golden and crispy; and inside, juicy and tender. There are some issues associated with preparing fried foods at home.

First, the contact of moisture-containing raw foods with hot oil produces grease splattering. Most times, the splattering liquids and food particles reach out of fry utensils to considerable distance. These will not only mess up stovetops and surrounding surfaces but also create undue oil burn injuries to the people who are preparing fried foods. The problem of grease fires in the kitchen as well as severe burns to people has been well documented.

Second, oil vapor is produced when oil is heated. The people who are preparing fried foods are forced to inhale considerable amount of cooking fumes during the cooking process. Oil vapor is harmful to human health and might pose long-term health threats to the people who expose themselves to oil vapor on a very regular base.

Third, the oil vapor generated in the cooking process might easily reach much farther in the kitchen or even other rooms and deposit on the furniture, paintings, electrical appliances, etc., thereby causing long-term hazards to home environment.

People have been using a lid to cover the fry pan or pot during the frying process for shielding the grease splattering. The problem with this approach lies on the fact that the steam generated during the frying process cannot get out of the fry utensil. It will distill on the lid and sidewall and then flow back to the fry utensil bottom. The moisture content within the fry utensil is excessively high for the foods. As a result, it takes longer time to fry the food and at the same time the fried food will easily be overcooked, consequently losing the important characteristics of fried foods. Obviously, such is seldom a desirable solution.

Over years, various devices have been developed to address the problem of undesirable grease splattering. Some patents have been granted.

U.S. Pat. No. 5,481,967, issued to Chen, on Jan. 9, 1996, describes a vented lid for baking and frying on a flat pan.

U.S. Pat. No. 5,531,354, issued to Uy, on Jul. 2, 1996, describes a spatter shielding and vapor venting device for a frying pan.

U.S. Pat. No. 5,542,347, issued to Joseph, on Aug. 6, 1996, describes a splattering containing device which comprises arcuate shield segments forming a collar around the perimeter of a frying pan cooking surface while suspended within the pan side walls.

All the aforementioned prior arts are concentrating on the issue of the splattering of hot grease and food particles. They fail to address the necessity of reducing the oil vapor content generated in the frying process to prevent the hazards to the people and environment. They also fail to address the issue associated with the moisture content within the fry utensil.

Some patents have been granted in the area of food processing equipment.

U.S. Pat. No. 4,854,949, issued to Giles, Sr. et al., on Aug. 8, 1989, describes an apparatus for cooking food including a ventless exhaust system.

U.S. Pat. No. 4,902,316, issued to Giles, Sr. et al., on Feb. 20, 1990, teaches an oven including a ventless exhaust system.

These two prior arts are concentrating on cooking fume treatment, the so-called ventless exhaust system. The systems discussed are specifically for business use. On the other hand, they fail to address the oil splattering issue, which is one of the primary issues associated with cooking at home.

Therefore, it remains desirable to provide fry utensils that can be used to prepare tasteful fried foods, that will minimize the splattering of hot grease and food particles, that will reduce the oil vapor content discharging into the kitchen room, and that will avoid long-term hazards to the people and home environment. Simply putting, it remains desirable to provide fry utensils that are more environment, people, and home friendly.

### SUMMARY OF THE INVENTION

Accordingly, the present invention is a forced venting fry utensil. The fry utensil comprises a lid, a container for holding and frying foods, a blowing device, a venting device, and a fluid-collecting rim.

The blowing device includes an in-take conduit having one end mounted on the upper portion of the fry utensil, an in-take filter removably engaged with the other end of the in-take conduit, a motor removably coupled with the in-take filter, a fan connected to the motor and inserted in the in-take filter, for forcing fresh air into the fry utensil, and a power supply operationally connected to the motor for providing power.

The venting device comprises a venting conduit with one end mounted on the upper portion of the fry utensil and a venting filter engaged with the other end of the venting conduit.

The fluid-collecting rim is engaged with the upper portion of the container for collecting the dripping-down water and the oil distilled on the lid and the venting filter.

Accordingly, the followings are some of the objects, features, and advantages of the present invention:

It is an object of the present invention to provide a fry utensil for use to prepare tasteful fried foods.

It is another object of the present invention to provide a fry utensil that prevents splattering liquids and food particles from reaching out of the fry utensil to mess up stovetops and surrounding surfaces and to cause undue oil burn injuries to the people who are preparing fried foods.

It is a further more object of the present invention to provide a fry utensil that reduces the oil vapor content in the grease-laden cooking fumes to minimize the long-term hazards to the people and home environment.

It is a feature of the present invention that this fry utensil is used with the lid fully covering the pan or pot, thereby preventing the grease splattering from reaching out.

It is another feature of the present invention that this fry utensil has a powered blowing device that continuously blows fresh air into the fry utensil and forces the moisture generated during the frying process out through a venting device.

It is a further more feature of the present invention that this fry utensil has a venting device with a venting conduit and a venting filter. The venting filter functions as an oil vapor filter to reduce the oil vapor content from the grease-laden heated air generated during the frying process.

It is still a further more feature of the present invention that this fry utensil has a fluid-collecting rim for collecting the water and oil distilled or trapped on the lid and the venting filter.

It is an advantage of the present invention that this fry utensil is environment, people, and home friendly.

Further more features and advantages of the present invention will be readily appreciated, as the same becomes better understood after reading the subsequent description when considered in connection with the accompanying drawings.

### BRIEF DESCRIPTION OF THE DRAWINGS

FIG. 1 illustrates an embodiment of the present invention.

FIG. 2 illustrates another embodiment of the present invention.

FIG. 3 illustrates a further more embodiment of the present invention.

FIG. 4 illustrates the partial cross-section of a prior art fry utensil design.

FIG. 5 illustrates the partial cross-section of an improved fry utensil design.

FIG. 6 illustrates a still further more embodiment of the present invention.

### DETAILED DESCRIPTION

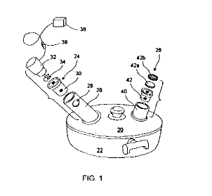

Reference is made to FIG. 1, which illustrates an embodiment of the present invention. The fry utensil comprises a lid 20, a fry pan 22, a blowing device 24, and a venting device 26.

Pan 22 is for holding and frying foods. Lid 20 is covering on top of pan 22. Pan 22 is, preferably, coated with a non-stick material.

Blowing device 24 includes an in-take conduit 28, an in-take filter 30, a motor 32, a fan 34, a power supply 36, and a switch 38.

The first end of in-take conduit 28 is mounted on lid 20. There is an opening (not shown) on lid 20 inline with in-take conduit 28 for allowing fresh air to be forced into the fry utensil. There is an opening 29 on in-take conduit 28, close to the second end of in-take conduit 28. Opening 29 functions as an air inlet. In-take conduit 28 also serves as a bracket for holding in-take filter 30 and motor 32. In-take filter 30 is removably engaged with the second end of in-take conduit 28. Motor 32 is removably coupled with in-take filter 30. Fan 34 is connected to motor 32 and inserted in in-take filter 30. Power supply 36 is operationally connected to motor 32 for providing power and is typically a DC adapter or a battery box or potentially the main power supply. Switch 38 is operationally coupled between power supply 36 and motor 32 for selectively activating or deactivating motor 32.

In-take conduit 28 can be specially designed such that it functions as a lid handle.

In-take filter 30 primarily functions as a shield for fan 34 and motor 32 against the splattering of grease and food particles and is typically made of one or multiple layers of meshes, preferably metal meshes, such as aluminum meshes. A predetermined strength is desired because In-take filter 30 is also used as a protection shield to fan 34 for avoiding potential injuries to the people.

Venting device 26 includes a venting conduit 40 and a venting filter 42.

The first end of venting conduit 40 is mounted on lid 20. There is an opening (not shown) on lid 20 inline with venting conduit 40 for allowing cooking fumes to be forced out through venting filter 42. Venting conduit 40 also serves as a bracket for holding venting filter 42. Venting filter 42 is removably engaged with the second end of venting conduit 40. Venting filter 42 can further includes a disposable paper filter 42a and/or a disposable activated charcoal filter 42b, together as an integrated filter.

Venting filter 42 is provided to condense the moisture content and trap the grease impurities in the moisture-laden and grease-laden air forced out from the fry utensil by fan 34. Venting filter 42 is preferably made of one or multiple layers of metal meshes, such as aluminum meshes. Metal meshes have different sizes of meshes and overlap each other. When the cooking fumes pass through, the moisture and the oil particles will be distilled or trapped on venting filter 42. Filters 42a and 42b are provided for further removing the remaining oil vapor and chemical contents in the cooking fumes and for removing the cooking fume odor before the air is exhausted into the room.

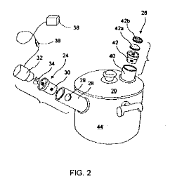

Reference is made to FIG. 2, which illustrates another embodiment of the present invention. The fry utensil comprises a lid 20, a deep fry pot 44, a blowing device 24, and a venting device 26. Fry pot 44 is, preferably, coated with a non-stick material. Since fry pot 44 has a deep sidewall, blowing device 24 can alternatively be mounted on the upper portion of the sidewall. The first end of in-take conduit 28 is mounted on the upper portion of the sidewall of fry pot 44. There is an opening (not shown) on the sidewall of fry pot 44 inline with in-take conduit 28 for allowing fresh air to be forced into the fry utensil. Other features are the same as what have been discussed previously.

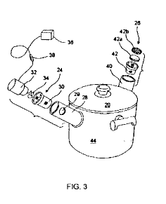

Reference is made to FIG. 3, which illustrates a further more embodiment of the present invention. The fry utensil comprises a lid 20, a deep fry pot 44, a blowing device 24, and a venting device 26. Since fry pot 44 has a deep sidewall, venting device 26 can alternatively be mounted on the upper portion of the sidewall of fry pot 44. The first end of venting conduit 40 is mounted on the upper portion of the sidewall of fry pot 44. There is an opening (not shown) on the sidewall of fry pot 44 inline with venting conduit 40 for allowing cooking fumes to be forced out. Other features are the same as what have been discussed previously.

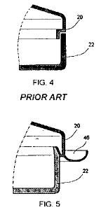

FIG. 4 illustrates the partial cross-section of a prior art fry utensil design. Lid 20 is covering fry pan 22. The lower portion of lid 20 is generally inside the upper portion of fry pan 22. This is an important drawback of prior art designs. This is because that consumer tends to use lid 20 as a grease shield. In this case, the moisture generated during the cooking process will distill on lid 20 and easily drip down into fry pan 22. As a result, the moisture level inside the fry utensil will be high.

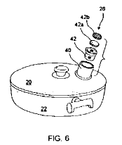

FIG. 5 illustrates the partial cross-section of an improved fry utensil design. The upper portion of fry pan 22 is forming a conical shape, tapered inwards. The lower portion of lid 20 generally extends outside the upper portion of fry pan 22 in the lateral direction. A fluid-collecting rim 46 is provided to collect the distilled water and oil dripping down on lid 20. Rim 46 is engaged with the upper portion of fry pan 22. The inner portion of rim 46follows the conical shape of and engages with the upper portion of fry pan 22. Therefore, lid 20 covers both the upper portion of fry pan 22 and the inner portion of rim 46.

The same design as shown in FIG. 5 is readily applicable to fry pot 44.

FIG. 6 illustrates a still further more embodiment of the present invention. This embodiment represents a reduced version of what have been discussed previously. The fry utensil comprises a lid 20, a fry pan 22, and a venting device 26. Venting device 26is mounted on lid 20. For fry pot 44, venting device 26 can alternatively be mounted on the upper portion of the sidewall.

The shapes and sizes of in-take conduit 28 and venting conduit 40 can be substantially different based on specific fry utensil designs.

In order to facilitate the distilled water to drip down along lid 20, a predetermined angle up is desired for lid 20 going from the outside to the center. The angle at which venting conduit 40 is mounted on lid 20 is also important to make sure that the condensed water and the trapped oil on venting filter 42 drips along lid 20 to rim 46. The dripping path should be generally smooth and downward.

In operation, a consumer:

First, loads fry pan 22 or deep fry pot 44 with oil and heats it halfway hot.

Second, lays raw foods in fry pan 22 or deep fry pot 44; covers fry pan 22 or deep fry pot 44 with lid 20 with blowing device 24 and venting device 26 assembled; and then turns on motor 32 and the heating high.

Third, cooks for a predetermined period of time and turns the heating low for a little while.

Fourth, stirs the foods or turns the foods around; covers fry pan 22 or deep fry pot 44; turns the heat high; and then cooks for another predetermined period of time.

Fifth, turns off the heating and then takes out the fried foods.

Finally, washes filters 30 and 42 and keeps them dry for reuse.

Accordingly, readers will see that this fry utensil can be used to prepare tasteful fried foods. This fry utensil is used with the lid fully covering the fry pan or deep fry pot, thereby dramatically reducing the grease splattering and the risk of oil burns. At the same time the grease-laden air generated during the frying process is forced through a venting device using a blowing device and filtered before being discharged into the kitchen, thereby avoiding long-term hazards to the people and home environment. The cleaning of the filters is easy.

The present invention has been described in an illustrative manner. It is to be understood that the terminology, which has been used, is intended to be in the nature of words of description rather than of limitation.

Although the invention has been described in its preferred forms and structures with a certain degree of particularity, these should not be construed as limiting the scope of the invention but as merely providing illustrations of some of the presently preferred embodiments of this invention.

For examples, although this invention has been described in a form of home fry utensils, it can have potential business use, such as use in restaurants. Therefore, this invention can alternatively be described as food processing equipment. Although this invention has been described in a form of stove heating fry utensils, it can readily be described in a form of electric-heating fry utensils. Although this invention has been described in a form of blowing fresh air into the fry utensil, it is understood that the rearrangement of the motor, fan, and filters, such that, instead of blowing fresh air into the fry utensil, the fan draws the moisture-laden and grease-laden air out of the fry utensil, is perfectly inline with the spirit of forced venting concept. Such rearrangement is, therefore, covered by the present invention.

Those skilled in the art can perceive improvements. For examples, obvious improvements can come with the additions of food manipulating devices and/or observation means.

Thus it is understood that the present disclosure of the preferred forms can be changed in the details of construction and in the combination and arrangement of parts without departing from the spirit and the scope of the invention as hereinafter claimed.

1. A fry utensil, said fry utensil comprising:
a container for holding and frying foods;
a lid for covering said container; and
a venting device mounted on said fry utensil, wherein said venting device includes a venting conduit having a first end mounted on said fry utensil and a second end, a venting filter engaged with said second end of said venting conduit.

2. A fry utensil as defined in claim 1, wherein said venting filter further includes an activated charcoal filter coupled with said venting filter for deodorizing the cooking fumes passing through said venting device.

3. A fry utensil as defined in claim 1, said fry utensil further including a fluid-collecting rim engaged with the upper portion of said container, and wherein the lower portion of said lid covers said container, such that said lid extends laterally outside both the upper portion of said container and the inner portion of said fluid-collecting rim.

4. A fry utensil as defined in claim 1, said fry utensil further including a blowing device, wherein said blowing device includes:
an in-take conduit having a first end mounted on said fry utensil and a second end;
a motor engaged with said second end of said in-take conduit;
a fan connected to said motor; and
a power supply operationally connected to said motor.

5. A fry utensil as defined in claim 4, said fry utensil further including a fluid-collecting rim engaged with the upper portion of said container, and wherein the lower portion of said lid covers said container, such that said lid extends laterally outside both the upper portion of said container and the inner portion of said fluid-collecting rim.

6. A fry utensil, said fry utensil comprising:
a container for holding and frying foods;
a lid for covering said container;
a blowing device mounted on said fry utensil; and
a venting device mounted on said fry utensil.

7. A fry utensil as defined in claim 6, wherein said blowing device includes:
an in-take conduit having a first end mounted on said lid and a second end;
a motor engaged with said second end of said in-take conduit;
a fan connected to said motor; and
a power supply operationally connected to said motor.

8. A fry utensil as defined in claim 7, wherein said blowing device further includes
an in-take filter engaged with said second end of said in-take conduit and coupled with said motor.

9. A fry utensil as defined in claim 6, wherein said blowing device includes:
an in-take conduit having a first end mounted on the sidewall of said container and a second end;
a motor engaged with said second end of said in-take conduit;
a fan connected to said motor; and
a power supply operationally connected to said motor.

10. A fry utensil as defined in claim 9, wherein said blowing device further includes
an in-take filter engaged with said second end of said in-take conduit and coupled with said motor.

11. A fry utensil as defined in claim 6, wherein said venting device includes:
a venting conduit having a first end mounted on said lid and a second end; and
a venting filter engaged with said second end of said venting conduit.

12. A fry utensil as defined in claim 11, wherein said venting device further includes
an activated charcoal filter coupled with said venting filter for deodorizing the fumes passing through said venting device.

13. A fry utensil as defined in claim 6, wherein said venting device includes:
a venting conduit having a first end mounted on the sidewall of said container and a second end; and
a venting filter engaged with said second end of said venting conduit.

14. A fry utensil as defined in claim 13, wherein said venting device further includes
an activated charcoal filter coupled with said venting filter for deodorizing the fumes passing through said venting device.

15. A fry utensil as defined in claim 6, said fry utensil further including a fluid-collecting rim engaged with the upper portion of said container, and wherein the lower portion of said lid covers said container, such that said lid extends laterally outside both the upper portion of said container and the inner portion of said fluid-collecting rim.

16. A fry utensil, said fry utensil comprising:
a container for holding and frying foods;
a fluid-collecting rim engaged with the upper portion of said container;
a lid for covering said container, such that said lid extends laterally outside both the upper portion of said container and the inner portion of said fluid-collecting rim.

17. A fry utensil as defined in claim 16, said fry utensil further including:
a blowing device mounted on said fry utensil; and
a venting device mounted on said fry utensil.

18. A fry utensil as defined in claim 17, wherein said blowing device includes:
an in-take conduit having a first end mounted on said fry utensil and a second end;
an in-take filter engaged with said second end of said in-take conduit;
a motor coupled with said in-take filter;
a fan connected to said motor; and
a power supply operationally connected to said motor.

19. A fry utensil as defined in claim 17, wherein said venting device includes:
a venting conduit having a first end mounted on said fry utensil and a second end; and
a venting filter engaged with said second end of said venting conduit.

20. A fry utensil as defined in claim 19, wherein said venting device further includes
an activated charcoal filter coupled with said venting filter for deodorizing the fumes passing through said venting device.
